(19) United States
(12) Patent Application Publication
(10) Pub. No.: US 2013/0290437 A1
(43) Pub. Date: Oct. 31, 2013

(54) SYSTEMS AND METHODS FOR MINING ORGANIZATIONAL DATA TO FORM SOCIAL NETWORKS

(71) Applicant: JOSEPH SAIB, Santa Clara, CA (US)

(72) Inventor: JOSEPH SAIB, Santa Clara, CA (US)

(73) Assignee: AppSense Limited, Warrington (GB)

(21) Appl. No.: 13/457,158

(22) Filed: Apr. 26, 2012

(51) Int. Cl. G06F 15/16; G06F 17/30

(52) U.S. Cl. 709/206; 707/776; 707/E17.014

(57) ABSTRACT

Systems and methods are provided for mining organizational data to form social networks, by identifying an initial user; sending a first query to a directory server for a first directory service record of the initial user; receiving and parsing the first directory service record of the initial user to determine at least one group to which the initial user belongs; sending a second query to the directory server for a second directory service record of the group; receiving and parsing the second directory service record of the group to determine at least one other user different from the initial user; and storing an association between the initial user and the other user in a storage medium, wherein the stored association forms part of a social network containing the initial user and the other user.

### CROSS-REFERENCE TO RELATED APPLICATIONS

This application is related to the following applications, filed herewith and hereby incorporated by reference: “Systems and Methods for Providing Data-Driven Document Suggestions” (U.S. Application No. TBD) and “Systems and Methods for Automatically Associating Tags With Files in a Computer System” (U.S. Application No. TBD).

### BACKGROUND

1. Technical Field

Disclosed systems and methods relate to mining organizational data to form social networks in a computer system.

2. Description of the Related Art

Traditionally, social networks are established and codified in a computer-readable form by means of direct control and intervention by a user. For example, on the Facebook social network, a user must specifically identify friends (by searching for or discovering them) and connect to them in order to form social network connections. This is true on many social networks, such as LinkedIn, Friendster, Orkut, Mixi, and others.

Some social networks attempt to partially automate the procedure of identifying friends by enabling a user to search the social network using the electronic mail addresses in the user's personal email address book. Once the user provides a social network with access to the email account, the social network connects to the email system of the user, downloads the address book, and automatically uses each email in the user's address book to determine which emails correspond to users that are already on the social network. However, the initiating user is still required to manually approve all friend requests.

There are disadvantages with the traditional social networking site. For instance, even though it may be advantageous for a corporate user to be able to indicate to software or other computing resources that the user is connected to other users within the organization, traditional social networking sites do not provide access or features customized for a secure corporate intranet. Further, in a corporate environment, it may be unnecessary to require a user to manually approve all friend requests if the objective is to codify relationships that exist in the organization, without requiring two users to have friendship or affinity ties with each other.

Therefore, there is a need in the art to provide alternative social networking systems for use on intranets and other networks. In particular, there is a need in the art to provide systems and methods for using organizational data to form social networks in a variety of situations.

Accordingly, it is desirable to provide methods and systems that overcome these and other deficiencies of the related art.

### SUMMARY

In accordance with the disclosed subject matter, systems and methods are provided for using organizational data to form social networks in a computer system.

The disclosed subject matter includes a method for mining organizational data to form a social network, the method comprising identifying an initial user; sending a first query to a directory server for a first directory service record of the initial user; receiving and parsing the first directory service record of the initial user to determine at least one group to which the initial user belongs; sending a second query to the directory server for a second directory service record of the group; receiving and parsing the second directory service record of the group to determine at least one other user different from the initial user; and storing an association between the initial user and the other user in a storage medium, wherein the stored association forms part of a social network containing the initial user and the other user.

The disclosed subject matter also includes sending a third query to the directory server for a third directory service record of the group; receiving and parsing the third directory service record of the group to determine a second group different from the group or a third user different from the initial user and the other user; and storing an association between the initial user and one of the second group and the third user. The disclosed subject matter also includes requesting approval prior to storing the association between the initial user and the other user in the storage system. The disclosed subject matter also includes applying a heuristic to determine whether to store the association between the initial user and the other user in the storage system. The disclosed subject matter also includes the heuristic based on a number of users in the group. The disclosed subject matter also includes the heuristic based on the physical location of the initial user and the other user. The disclosed subject matter also includes sending a third query to an email server for an email record of the initial user; receiving and parsing the email record of the initial user to determine at least one additional user different from the initial user based on at least one of email sent from the initial user to the additional user or from the additional user to the initial user; and storing a second association between the initial user and the additional user in the storage medium, wherein the stored second association forms part of the social network containing the initial user, the other user, and the additional user.

The disclosed subject matter also includes a system for providing document suggestions in a communications network, the system comprising: one or more interfaces configured to provide communication with a server via communication network; and a processor, in communication with the one or more interfaces, and configured to run a module stored in memory that is configured to: identify an initial user; send a first query to a directory server for a first directory service record of the initial user; receive and parse the first directory service record of the initial user to determine at least one group to which the initial user belongs; send a second query to the directory server for a second directory service record of the group; receive and parsing the second directory service record of the group to determine at least one other user different from the initial user; and store an association between the initial user and the other user in a storage medium, wherein the stored association forms part of a social network containing the initial user and the other user, wherein the stored second association forms part of the social network containing the initial user, the other user, and the additional user.

The disclosed subject matter also includes the processor configured to: send a third query to the directory server for a third directory service record of the group; receive and parse the third directory service record to determine a second group different from the group or a third user different from the initial user and the other user; and store an association between the initial user and one of the second group and the third user. The disclosed subject matter also includes the processor configured to request approval prior to storing an association between the initial user and the other user in the storage system. The disclosed subject matter also includes the processor configured to apply a heuristic to determine whether to store the association between the initial user and the other user in the storage system. The disclosed subject matter also includes the heuristic being based on a number of users in the group. The disclosed subject matter also includes the processor configured to send a third query to an email server for an email record of the initial user; receive and parse the email record of the initial user to determine at least one additional user different from the initial user based on at least one of email sent from the initial user to the additional user or from the additional user to the initial user; and store a second association between the initial user and the additional user in the storage medium, wherein the stored second association forms part of the social network containing the initial user, the other user, and the additional user.

The disclosed subject matter also includes a non-transitory computer-readable medium having executable instructions operable to cause a device to: identify an initial user; send a first query to a directory server for a first directory service record of the initial user; receive and parse the first directory service record of the initial user to determine at least one group to which the initial user belongs; send a second query to the directory server for a second directory service record of the group; receive and parsing the second directory service record of the group to determine at least one other user different from the initial user; and store an association between the initial user and the other user in a storage medium, wherein the stored association forms part of a social network containing the initial user and the other user, wherein the stored second association forms part of the social network containing the initial user, the other user, and the additional user.

The disclosed subject matter also includes instructions operable to cause a device to send a third query to the directory server for a third directory service record of the group; receive and parse the third directory service record to determine a second group different from the group or a third user different from the initial user and the other user; and store an association between the initial user and one of the second group and the third user. The disclosed subject matter also includes instructions operable to cause a device to request approval prior to storing an association between the initial user and the other user in the storage system. The disclosed subject matter also includes instructions operable to cause a device to apply a heuristic to determine whether to store the association between the initial user and the other user in the storage system. The disclosed subject matter also includes the heuristic being based on a number of users in the group. The disclosed subject matter also includes the heuristic being based on the physical location of the initial user and the other user. The disclosed subject matter also includes instructions operable to cause a device to send a third query to an email server for an email record of the initial user; receive and parse the email record of the initial user to determine at least one additional user different from the initial user based on at least one of email sent from the initial user to the additional user or from the additional user to the initial user; and store a second association between the initial user and the additional user in the storage medium, wherein the stored second association forms part of the social network containing the initial user, the other user, and the additional user.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter and which will form the subject matter of the claims appended hereto.

In this respect, before explaining at least one embodiment of the disclosed subject matter in detail, it is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the disclosed subject matter. It is important, therefore, that the claims be regarded as including such equivalent constructions insofar as they do not depart from the spirit and scope of the disclosed subject matter.

These together with the other objects of the disclosed subject matter, along with the various features of novelty which characterize the disclosed subject matter, are pointed out with particularity in the claims annexed to and forming a part of this disclosure. For a better understanding of the disclosed subject matter, its operating advantages and the specific objects attained by its uses, reference should be had to the accompanying drawings and descriptive matter in which there are illustrated preferred embodiments of the disclosed subject matter.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 is a network connectivity diagram of a networked system in accordance with some embodiments of the invention.

FIG. 2 is a schematic diagram of organizational information stored at a directory server in accordance with some embodiments of the invention.

FIG. 3 is a flow diagram of identifying documents for suggestion in accordance with certain embodiments of the invention.

FIG. 4 illustrates a block diagram of a server device in accordance with certain embodiments of the invention.

### DETAILED DESCRIPTION

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the subject matter of the disclosed subject matter. In addition, it will be understood that the examples provided below are exemplary, and that it is contemplated that there are other systems and methods that are within the scope of the disclosed subject matter.

Users of present-day computer systems often use social networking tools to connect to one another for various purposes. Such social networking tools commonly include Facebook, Twitter, and LinkedIn, among others. These social networks are not specifically established for use by companies or other organizations, but can be used to provide useful features to employees. For example, social networks can be used to efficiently share information in the form of links, documents, and/or status updates among users. By tracking these types of information as they are shared or consumed by a user, social networks can also be used to provide other automated systems a window into the activity of a particular user.

However, social networks designed for the general public are not always useful within the context of a company or organization. Typical organizations have a need to maintain some information as confidential within the organization or to particular outside individuals or organizations. Employees of such organizations cannot use Facebook or Twitter to share confidential information with others, because doing so would result in the violation of the organization's security policies. Companies and other organizations to date have therefore spent a significant amount of time investing in social networking tools that approximate the tools offered by social networks available to the general public, while being secure and providing the ability for an organization to control its information. Examples of such software include Drupal and Microsoft SharePoint, as well as Lotus Notes and the Jabber/XMPP messaging protocol.

Email can also be thought of as a form of social networking. Most organizations have come to adopt email as a means of communications that is fast, secure, simple, and offers the ability to transfer files and to perform other tasks such as scheduling. However, email does not offer some of the explicit sharing technologies that make social networking powerful.

Although these approaches have strengths and will undoubtedly continue to be available on enterprise and organizational computer systems, an approach is suggested herein that is compatible with one or more social networking tools currently used in the enterprise. The approach uses built-in connections at a directory server to automatically determine connections between people for developing a social network within an organization. There are many situations in which this would be useful, and an exemplary system is described below for providing such a document suggestion system.

Directory services are software systems that store, organize, and provide access to information such as email addresses, printers, users, groups, devices, telephone numbers and other objects. Many directory services exist, but the advent of email has resulted in the common usage of directory services based on the X.500 Internet protocol, and more recently in the usage of directory services based on Lightweight Directory Access Protocol (LDAP) and Microsoft Active Directory. While these directory services are the focus of the invention as described below, some embodiments of the invention may use other directory services, such as the domain name system (DNS), Hesiod, Sun Network Information Services (NIS), Novell eDirectory, Apple Open Directory, Lotus Domino, or OpenLDAP, among other such services, to provide the services described below.

In a directory service such as LDAP, directory entries includes sets of attributes, one of which is a unique identifier. These entries are organized in a tree, such that entries may have parent, child, and/or sibling entries. The LDAP directory server thus hosts a single directory tree, which consists of many sub-trees. Beyond this basic structure, organizations are free to impose their own structure on the directory tree using schemas to define the types of entries and possible connections between them. One typical use of LDAP is to have organizational units (OUs) represented as directory entries, with users as sub-entries located under an organizational unit. Users are represented as entries that have supervisors and/or belong to organizational units. This structure is straightforward to implement in many cases, as it requires simply that the LDAP tree mirror the organizational chart of the company.

The following is what an LDAP entry may look like when represented in LDAP Data Interchange Format:

dn: cn=John Doe,dc=example,dc=com
cn: John Doe
givenName: John
sn: Doe
telephoneNumber: +1 888 555 6789
telephoneNumber: +1 888 555 1232
mail: john@example.com
manager: cn=Barbara Doe,dc=example,dc=com
objectClass: inetOrgPerson
objectClass: organizationalPerson
objectClass: person
objectClass: top

In the exemplary LDAP entry shown above, the Distinguished Name (“dn”) attribute of the entry has a compound value that includes a Common Name (“cn”), “John Doe,” followed by Domain Components (“dc”) example and com. This is typical of a user named John Doe that is employed at a corporation whose Internet domain is example.com. Further down in the entry we see the user's common name repeated (“John Doe”), his given name and surname (“sn”), his telephone number and email address, and information about who John's manager is (“Barbara Doe”). The objectClass attribute contains several values that correspond to a schema. Each site has an LDAP schema, which defines exactly how objectClasses relate to one another. The objectClass attribute typically has the values “user,” indicating that the LDAP entry relates to a person, or “computer,” indicating that the LDAP entry is a computer, or “organizationalUnit,” indicating that the LDAP entry corresponds to an organizational unit in the company or organization.

The present disclosure describes a method for using a directory tree, such as an LDAP directory tree, to facilitate the formation of social networks. It is possible to use the LDAP directory tree to establish basic social networks that follow the structure of the organization. This is possible using the assumption that people who work in the same group are connected to each other as either parent, child or sibling nodes within the LDAP directory tree. For example, if Bob and Mary are both employees of company NewCo, Bob may know Mary. Further, if Bob and Mary share the same supervisor, and if Bob and Mary are the only subordinates of that supervisor, it is highly likely that Bob knows Mary. Bob also certainly knows his supervisor. These connections may be used to automatically form social networks.

In some embodiments, a method to facilitate the creation of social networks may be used as follows. For a given user, a social networking system may query the directory server for the directory entry for that user. The system may determine, from the directory entry, whether the user has supervisors, subordinates, peers, or belongs to one or more organizational units. If the user does not have any of these connections, the system may look at a job title or a job function, which may be described in the directory entry. The system may also look at the user's physical location, which is often specified at a directory server. For each group that the user is a part of, the system may either query the directory server to determine the members of the group, or may know this information a priori or via previous queries. Certain heuristics may then be applied to determine whether the user is likely to know the members of the groups. The resultant list of users is a list of people that the user is likely to know. If the system is configured for automated operation, the system may submit these users to the corporate social networking system as connections for the initial user. If the system is configured for semi-automatic operation, the system may submit these users to the user so that he or she can approve the connection requests. By querying the directory server, mining of organizational data is used to effectively form a social network.

The social networking system may be a traditional social networking site, such as Facebook or LinkedIn. However, it may also be an enterprise social networking tool, such as Lotus Notes or Jabber, or another XMPP-compliant messaging client. It may also be another type of social networking system. One type of social networking system that may be used is an implicit social networking model maintained by other servers or devices, such as an AppSense document suggestion system. Having social information may be helpful for a document suggestion system, as the system can rank higher the documents that are sent from or opened by coworkers that a user is acquainted with. Such a social network may not require the user to be able to act on the social information, as the value of such a network is provided by increased predictive accuracy. This type of social network may be referred to as a non-interactive social network, and may provide value for other software programs. For example, a document suggestion application may use such a non-interactive social network to provide suggestions for a user that are augmented with suggestions derived from other users in the user's social network.

In some embodiments, it is possible to form a non-interactive social network automatically. Once a directory server, such as an LDAP server, is available, it is possible to retrieve all entries representing people and organizational units from the server, according to the above description, and to determine who is connected to whom throughout the organization. This information may be automatically stored in a non-interactive social network and used to improve the predictive efficiency of various systems. In certain embodiments, including embodiments using a non-interactive social network, the system may be kept up-to-date by periodically re-performing these steps.

In certain embodiments, another type of directory server may be used instead of an LDAP server. This may be done using built-in LDAP functionality in the alternate directory server, or it may be done using native support for the alternate directory protocol, such as Microsoft Active Directory. The method described herein may be modified according to what is possible using the particular directory service being used.

Alternately, in certain embodiments, it is possible to integrate the social networking system as a component of the directory server. The directory server may directly access its own underlying data to determine who is connected and to create an implicit social network. When integrated with the directory server, the social networking system may be located at a server. If it is not advantageous to locate the social networking system at a server, for example if the server is located at a remote network location that is inaccessible or inconvenient to access, it may be possible to set up a server process on a device that is local to the network.

In certain embodiments, social connection detection using a directory server may be combined with social connection detection using other means. For example, the other means may include an email address book, an email inbox, or a list of phone numbers or cell phone contact list. Each of these databases may minimally contain the name of a contact and a means for contacting the contact. The fact that a user has retained this contact information may be used as implicit proof of connection. However, the contact information available in such databases is flat and does not reveal an organization's hierarchy, making the directory services implementation more useful.

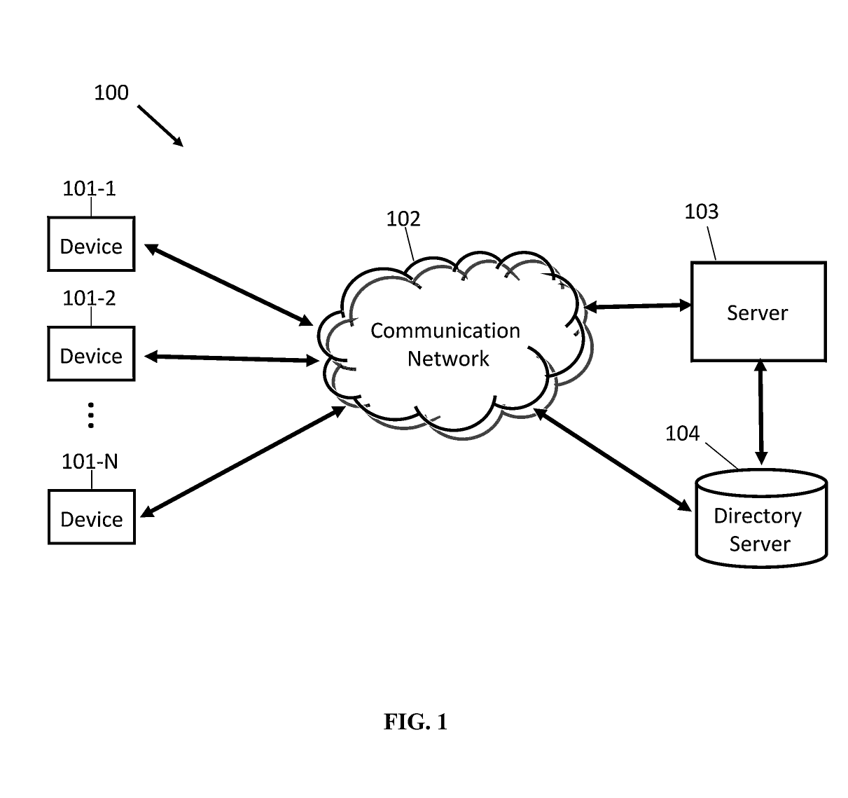

FIG. 1 is a network connectivity diagram of a networked system in accordance with some embodiments of the invention. Network system 100 is a client/server system, in which at least one client 101 (e.g., devices 101-1, 101-1, . . . 101-n) and server 103 communicate via communication network 102. Device 101 is a mobile device or user—operated device associated with a user. Device 101 can be any suitable device, including desktop computers, mobile computers, tablet computers, and cellular phones including smartphones (e.g., Apple iPhones or Android-based smartphones). Users use device 101 to communicate with applications on server 103. Server 103 saves data to, and retrieves data from, directory server 104. Directory server 104 may be an LDAP server, a Microsoft Active Directory server, or other directory server. The directory server may also be remote from the server or located in a cloud or in another location accessible via the network. In some embodiments, directory server 104 is accessed by server 103 and also by other devices on the communication network 102, including devices 101. In some embodiments, device 101 may run only standard application programs and standard operating system software, such as Microsoft Outlook running on a version of the Microsoft Windows operating system. In other embodiments, device 101 may run specialized or customized application programs that communicate with social network discovery software on server 103.

In some embodiments of the invention, server 103 may be a social networking server. Users may initiate various operations relating to social networking at devices 101, such as requesting access to a social network, requesting other users to connect to them on the social network, approving automatically-suggested users as connections on the social network, posting updates, links or files on the social network, reading posted information that others have saved on the social network, or performing instant messaging functions with users on the social network. Users may also use devices 101 for email and other social functions that utilize either directory server 104 or social networking server 103. The social network may be controlled and implemented by software running on social networking server 103, or elsewhere within the organization, or in a remote location, or at a remote site operated by a third party. The social network may use a social network discovery module in accordance with some embodiments of the invention.

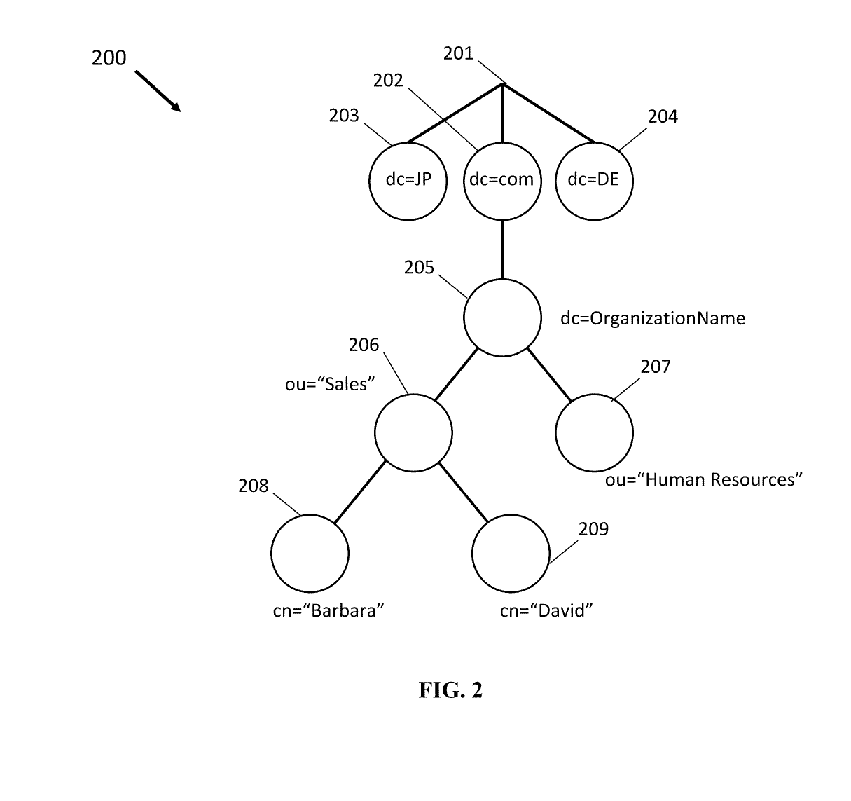

FIG. 2 is a schematic diagram of organizational information stored at a directory server, in accordance with some embodiments of the invention. A directory server is a server that provides directory information to users on a network, and may use protocols such as Lightweight Directory Access Protocol (LDAP), Microsoft Active Directory, or other protocols. In a directory server, information may be stored in a Directory Information Tree (DIT). In the DIT, entries (represented in FIG. 2 by circles) are connected with each other by bidirectional links. For two entries that are connected to each other, if one entry is closer to the root of the tree than the other entry, that entry is referred to as the parent entry, and the other entry is referred to as the child entry. Two entries that are at the same level on the tree and that are children of the same parent entry may be referred to as sibling entries.

Information within entries can be represented as a series of name-value pairs, called attributes. Each entry contains a Distinguished Name (DN). An example of a DN, as referenced above, is:

dn: cn=John Doe,dc=example,dc=com

where CN is the Common Name, and DC is a Domain Component, showing the relationship of the CN to the overall DIT. The connections between entries are also created by information stored within the entries. For example, a manager may be identified using an attribute with the name “Manager,” and the value of the attribute would be an identifier of the user's manager, using a unique ID or using a Distinguished Name or Common Name, or another identifier. Other attributes may be used to identify supervisors and subordinates. Other attributes may also be used to identify the name of a group that a user belongs to.

LDAP also allows for abstract groups within an organization to be represented, using an attribute that may be called OU, or “Organizational Unit.” OU nodes may list user nodes as members, thereby indicating the structure of an organization.

In FIG. 2, schematic diagram 200 is a diagram showing the Directory Information Tree (DIT), according to some embodiments. The DIT includes root 201, which is the top of the tree structure. Below root 201, various nodes are shown that reflect the structure of a hypothetical corporation. The corporation has subsidiaries in the U.S., Japan, and Germany, which are reflected by node 202 (“dc=com”), node 203 (“dc=JP”), and node 204 (“dc=DE”) DC stands for Domain Component in this figure; it is an LDAP attribute that is used to promote similarity between an LDAP DIT and the hierarchical organization of the Internet Domain Name System (DNS), for various reasons that are well-known. (For this reason, the U.S. organization is categorized with the value dc=com, corresponding to the U.S.-centric top-level domain.com.)

Node 205 is a node with domain component “OrganizationName.” Since node 205 is a child of node 202, it is understood that it represents the U.S. corporate organization. Nodes 206 and 207 are sub-organizations for different organizational units (OUs) within node 205. Node 206 is the sales organization (“ou=sales”) and node 207 is the human resources organization (“ou=Human Resources”). Nodes 208 and 209 represent users Barbara and David, respectively, as indicated by their Common Name (CN) fields. Nodes 208 and 209 are subordinate to node 206, which represents the sales organization. This structure represents Barbara (node 208) and David (node 209) as being part of the sales organization. Though this figure is a schematic diagram, in the case shown, there are only two users in the sales organization, making it highly likely that they know each other. These two users would therefore be good candidates to be receive suggestions to connect with the other user in a companywide social network.

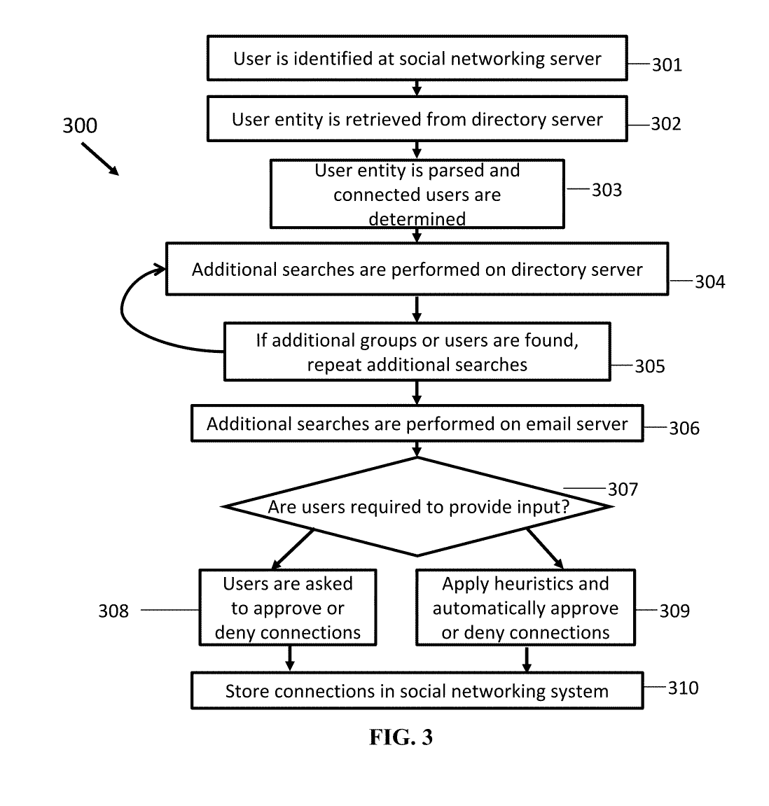

FIG. 3 is a flow diagram of identifying documents for suggestion in accordance with certain embodiments of the invention. Flow diagram 300 shows the following steps. At step 301, a user is identified at a social networking server. The social networking server may be located at server 103, and may be part of a corporate or organizational intranet that includes many different services. Identification of the user may entail identification of a directory server, such as an LDAP server, for the corporation or organization.

At step 302, after the user is identified, the entity relating to the user is selected by performing, on the directory server, a search for a unique ID of the user, such as a common name (CN), distinguished name (DN), user id (UID), or email address. Any other suitable unique ID or combinations of unique IDs may be used. Search is a common function that is well-supported on LDAP servers and other directory servers. One or more references to a directory entry may be returned and identified as the user in question. Once the directory entry corresponding to the user is selected, at step 303, the directory entry is parsed and/or analyzed to determine if there are any other users, supervisors, subordinates, or peers that are connected to this user. Each such user is added to a list of people to which the identified user may want to connect.

At step 304, additional searches are performed on the directory server to find additional users to which the identified user may want to connect. If the user is part of any groups, the directory server is queried for the entity corresponding to each of these groups. The group entities are then parsed, and any users that are in the group may be added to the list. If the identified user is a supervisor of an organizational unit, the members of the organizational unit may be discovered and added to the list in a similar fashion. If the identified user has a physical location that is listed in his or her entry, a search may be performed for other users at that physical location, and users that are found as a result of that search may be added to the list as well. For example, if Bob belongs to the Management group but does not have a supervisor listed in his user entity, and the Management group has the CEO, Tom, as its supervisor, Tom should be added to the list. This may result in repeating step 304, as shown by step 305. Processing may proceed using a depth-first-search or other algorithm. A depth-first search, as is known in the art, is the traversal of a tree structure using a search queue in which child nodes are added to the tail of the search queue before sibling nodes.

In some embodiments, steps 301-305 may be performed on non-LDAP directory servers, including UNIX login servers, Windows domain servers, remote authentication dial-in user service (RADIUS) or Diameter servers, and/or other authentication servers. Each of these types of authentication servers support searching for users, identifying users, and identifying groups to which a user may. This may be used to populate a list of users to which a particular user may want to connect. Each of the steps above may be adapted for performance with each of these authentication servers. In some embodiments, the queried authentication server may not support hierarchical organizations of users, in which case the flat organization of such an authentication server is used as a degenerate case of the hierarchical case.

At step 306, in some embodiments, additional searches may also be performed using email as a data source. The search may review recent emails and add the most recent senders of emails, or the recipients of the user's last ten emails. Identifying relevant users in email may be based on many factors that may include a relevant time period, the frequency of exchange of emails to and from the user, the closeness of the sender and recipient on the organizational chart (derived from directory server information), a number of most recent emails, and other factors. This allows for the discovery of ad-hoc groups that may have formed recently or may be formed to handle a short-term or small project, without requiring the directory server to be immediately updated. The information derived from using email as a data source may be correlated with information from the directory server. Searches may be performed at an email server, or may be performed at a client in some embodiments.

In some embodiments, processing may depend on whether users are required to provide input, shown at step 307. Once a list of suggested connections in the social networking system is determined, users may be asked to approve or deny connections with any or all suggested users manually, in which case all approved connections are created within the social networking system. This is shown in step 308. In other embodiments, some or all of the suggested connections may be made automatically without user input. In some embodiments, the number of automatically-determined connections may be limited based on various heuristics, in order to prevent users who do not personally know each other from being stored as connections in the social networking system. Such heuristics may include, for example, adding users in a group to the list of connected users only if the group does not exceed a certain size; adding users if they are less than three hierarchical steps removed; filtering users who are not located at the same physical location; increasing the likelihood that two users are connected if their physical locations are proximate; adding users if they have previously worked together based on information about past organizational structures; or other factors. This is shown in step 309.

At step 310, once the set of users to be connected to the identified user is determined, the social networking system stores each of the connections. The steps may be repeated for one or more additional users.

An example of the flow diagram of FIG. 3, in accordance with some embodiments and as applied to the organizational structure of FIG. 2, is shown as follows. At step 301, David is identified at the social networking server 103 as the identified user, who is operating the system and who will be provided with an automatically-generated social network. At step 302, David's user entity 209 is retrieved from the directory server 104. At step 303, David's user entity 209 is parsed. For example, David's user entity 209 indicates that he is not connected to any other users but is connected to organizational unit 206, “Sales.” At step 304, entity 206 is retrieved. At step 305, entity 206, “Sales,” is parsed and the system determines that Barbara, entity 208, is connected to “Sales.” Barbara is added to the list. Processing returns to step 304, and Barbara's user entity 208 is retrieved. However, once Barbara's user entity 208 is retrieved, it is found that she has no more connections. Processing proceeds through step 306. In this example, David has not received any emails, and so step 306 is skipped. In this example, at step 307, it is determined that users are not required to provide input. Processing proceeds to step 309, where a heuristic determines that since the group Sales is only two people, it is likely that David knows Barbara. The connection is therefore approved. At step 310, David's connection to Barbara is stored. The social network is complete and may now be used to provide document suggestions, so that documents reviewed by Barbara may be suggested to David.

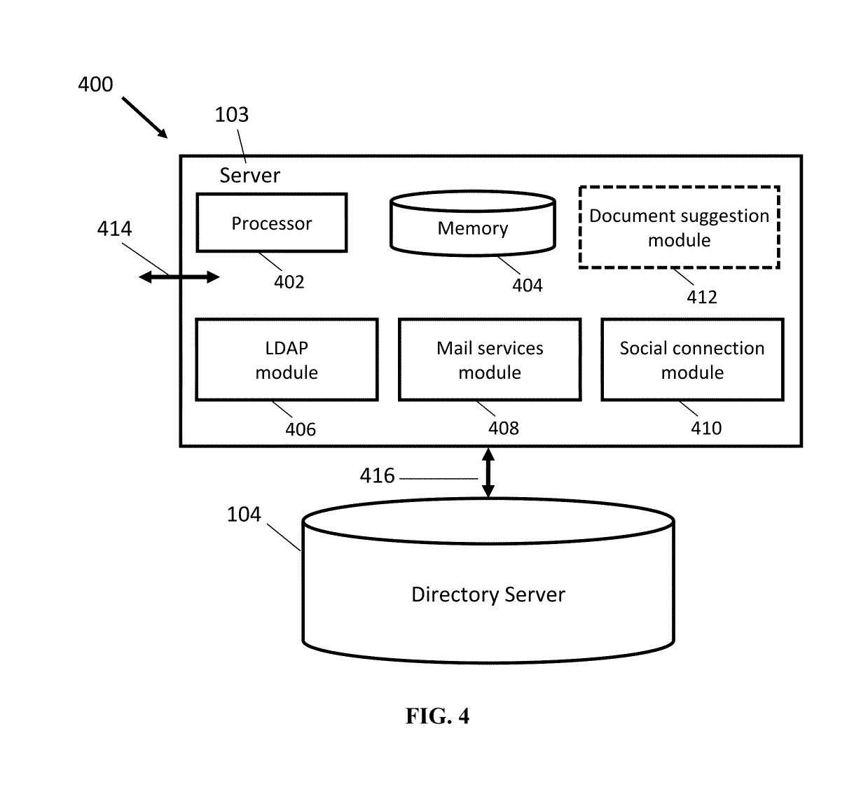

FIG. 4 is a block diagram of a server device in accordance with certain embodiments of the invention. Block diagram 400 shows server 103 in communication with directory server 104. Server 103 includes processor 402, memory 404, LDAP module 406, mail services module 408, social connection module 410, and optionally document suggestion module 412. Server 103 communicates with various network hosts using interface 414, and with directory server 104 using interface 416. Processor 402 performs processing for one or more modules as disclosed in this specification. Memory 404 provides temporary storage of data as required by the processor 402. The memory 404 can be a non-transitory computer readable medium, flash memory, a magnetic disk drive, an optical drive, a programmable read-only memory (PROM), a read-only memory (ROM), or any other memory or combination of memories. The software runs on a processor 402 capable of executing computer instructions or computer code. The processor 402 might also be implemented in hardware using an application specific integrated circuit (ASIC), programmable logic array (PLA), field programmable gate array (FPGA), or any other integrated circuit.

Although processor 402 performs each of the functions described in the flow diagram of FIG. 3, multiple sub-modules may exist within either the software or hardware of server 103 that provide supporting functionality. LDAP module 406 may be used to communicate with an LDAP server or other directory server, and may be responsible for formatting search queries according to the LDAP protocol or another protocol, as needed by the system. Mail services module 408 may be used to communicate with a mail server, such as a Microsoft Exchange server, to identify recipients of emails that may be added to the list of users for social network connection formation. Communication with the mail server may use a standard application programming interface (API), or may involve code that executes on the client device 101 that communicates back to the mail services module 408 on server 103. Social connection module 410 may be used to communicate with an external social network server, if one is present, or may be used to provide social networking services to users, in some embodiments. Social connection module 410 may be used to store the connections between the identified user and the additional users that are suggested for potential connections. Document suggestion module 412 is an optional module that may provide document suggestions based on user actions, as described more fully in U.S. App. No. [TBD], filed concurrently and hereby incorporated by reference.

Interface 414 and interface 416 may be the same interface or different interfaces. Interfaces 414 and 416 may allow server 103 to communicate with other systems, such as other devices on one or more networks, server devices on the same or different networks, or user devices either directly or via intermediate networks. Interfaces 414 and 416 may be implemented in hardware to send and receive signals in a variety of mediums, such as optical, copper, and wireless, and in a number of different protocols some of which may be non-transient.

The server 103 can operate using an operating system (OS) software. In some embodiments, the OS software is based on a Linux software kernel and runs specific applications in the server such as monitoring tasks and providing protocol stacks. The OS software allows server resources to be allocated separately for control and data paths. For example, certain packet accelerator cards and packet services cards are dedicated to performing routing or security control functions, while other packet accelerator cards/packet services cards are dedicated to processing user session traffic. As network requirements change, hardware resources can be dynamically deployed to meet the requirements in some embodiments.

The server's software can be divided into a series of tasks that perform specific functions. These tasks communicate with each other as needed to share control and data information throughout the server 103. A task can be a software process that performs a specific function related to system control or session processing. Three types of tasks operate within the server 103 in some embodiments: critical tasks, controller tasks, and manager tasks. The critical tasks control functions that relate to the server's ability to process calls such as server initialization, error detection, and recovery tasks. The controller tasks can mask the distributed nature of the software from the user and perform tasks such as monitoring the state of subordinate manager(s), providing for intra-manager communication within the same subsystem, and enabling inter-subsystem communication by communicating with controller(s) belonging to other subsystems. The manager tasks can control system resources and maintain logical mappings between system resources.

Individual tasks that run on processors in the application cards can be divided into subsystems. A subsystem is a software element that either performs a specific task or is a culmination of multiple other tasks. A single subsystem includes critical tasks, controller tasks, and manager tasks. Some of the subsystems that run on the server 103 include a system initiation task subsystem, a high availability task subsystem, a shared configuration task subsystem, and a resource management subsystem.

The system initiation task subsystem is responsible for starting a set of initial tasks at system startup and providing individual tasks as needed. The high availability task subsystem works in conjunction with the recovery control task subsystem to maintain the operational state of the server 103 by monitoring the various software and hardware components of the server 103. Recovery control task subsystem is responsible for executing a recovery action for failures that occur in the server 103 and receives recovery actions from the high availability task subsystem. Processing tasks are distributed into multiple instances running in parallel so if an unrecoverable software fault occurs, the entire processing capabilities for that task are not lost. User session processes can be sub-grouped into collections of sessions so that if a problem is encountered in one sub-group users in another sub-group will not be affected by that problem.

Shared configuration task subsystem can provide the server 900 with an ability to set, retrieve, and receive notification of server configuration parameter changes and is responsible for storing configuration data for the applications running within the server 900. A resource management subsystem is responsible for assigning resources (e.g., processor and memory capabilities) to tasks and for monitoring the task's use of the resources.

In some embodiments, the server 103 can reside in a data center and form a node in a cloud computing infrastructure. The server 103 can also provide services on demand. A module hosting a client is capable of migrating from one server to another server seamlessly, without causing program faults or system breakdown. The server 103 in the cloud can be managed using a management system.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A method for mining organizational data to form a social network, the method comprising:
identifying an initial user;
sending a first query to a directory server for a first directory service record of the initial user;
receiving and parsing the first directory service record of the initial user to determine at least one group to which the initial user belongs;
sending a second query to the directory server for a second directory service record of the group;
receiving and parsing the second directory service record of the group to determine at least one other user different from the initial user; and
storing an association between the initial user and the other user in a storage medium, wherein the stored association forms part of a social network containing the initial user and the other user.

2. The method of claim 1, further comprising:
sending a third query to the directory server for a third directory service record of the group;
receiving and parsing the third directory service record of the group to determine a second group different from the group or a third user different from the initial user and the other user; and
storing an association between the initial user and one of the second group and the third user.

3. The method of claim 1, further comprising requesting approval prior to storing the association between the initial user and the other user in the storage system.

4. The method of claim 1, further comprising applying a heuristic to determine whether to store the association between the initial user and the other user in the storage system.

5. The method of claim 4, wherein the heuristic is based on a number of users in the group.

6. The method of claim 4, wherein the heuristic is based on the physical location of the initial user and the other user.

7. The method of claim 1, further comprising:
sending a third query to an email server for an email record of the initial user;
receiving and parsing the email record of the initial user to determine at least one additional user different from the initial user based on at least one of email sent from the initial user to the additional user or from the additional user to the initial user; and
storing a second association between the initial user and the additional user in the storage medium, wherein the stored second association forms part of the social network containing the initial user, the other user, and the additional user.

8. A system for providing document suggestions in a communications network, the system comprising:
one or more interfaces configured to provide communication with a server via communication network; and
a processor, in communication with the one or more interfaces, and configured to run a module stored in memory that is configured to:
identify an initial user;
send a first query to a directory server for a first directory service record of the initial user;
receive and parse the first directory service record of the initial user to determine at least one group to which the initial user belongs;
send a second query to the directory server for a second directory service record of the group;
receive and parsing the second directory service record of the group to determine at least one other user different from the initial user; and
store an association between the initial user and the other user in a storage medium, wherein the stored association forms part of a social network containing the initial user and the other user,
wherein the stored second association forms part of the social network containing the initial user, the other user, and the additional user.

9. The system of claim 8, further comprising the processor configured to:
send a third query to the directory server for a third directory service record of the group;
receive and parse the third directory service record to determine a second group different from the group or a third user different from the initial user and the other user; and
store an association between the initial user and one of the second group and the third user.

10. The system of claim 8, further comprising the processor configured to request approval prior to storing an association between the initial user and the other user in the storage system.

11. The system of claim 8, further comprising the processor configured to apply a heuristic to determine whether to store the association between the initial user and the other user in the storage system.

12. The system of claim 11, further comprising the heuristic being based on a number of users in the group.

13. The system of claim 8, further comprising the processor configured to
send a third query to an email server for an email record of the initial user;
receive and parse the email record of the initial user to determine at least one additional user different from the initial user based on at least one of email sent from the initial user to the additional user or from the additional user to the initial user; and
store a second association between the initial user and the additional user in the storage medium,
wherein the stored second association forms part of the social network containing the initial user, the other user, and the additional user.

14. A non-transitory computer-readable medium having executable instructions operable to cause a device to:
identify an initial user;
send a first query to a directory server for a first directory service record of the initial user;
receive and parse the first directory service record of the initial user to determine at least one group to which the initial user belongs;
send a second query to the directory server for a second directory service record of the group;
receive and parsing the second directory service record of the group to determine at least one other user different from the initial user; and
store an association between the initial user and the other user in a storage medium, wherein the stored association forms part of a social network containing the initial user and the other user,
wherein the stored second association forms part of the social network containing the initial user, the other user, and the additional user.

15. The medium of claim 14, further comprising instructions operable to cause a device to
send a third query to the directory server for a third directory service record of the group;
receive and parse the third directory service record to determine a second group different from the group or a third user different from the initial user and the other user; and
store an association between the initial user and one of the second group and the third user.

16. The medium of claim 14, further comprising instructions operable to cause a device to request approval prior to storing an association between the initial user and the other user in the storage system.

17. The medium of claim 14, further comprising instructions operable to cause a device to apply a heuristic to determine whether to store the association between the initial user and the other user in the storage system.

18. The medium of claim 17, further comprising the heuristic being based on a number of users in the group.

19. The medium of claim 17, further comprising the heuristic being based on the physical location of the initial user and the other user.

20. The medium of claim 14, further comprising instructions operable to cause a device to
send a third query to an email server for an email record of the initial user;
receive and parse the email record of the initial user to determine at least one additional user different from the initial user based on at least one of email sent from the initial user to the additional user or from the additional user to the initial user; and
store a second association between the initial user and the additional user in the storage medium,
wherein the stored second association forms part of the social network containing the initial user, the other user, and the additional user.
